(19) United States
(12) Patent Application Publication
(10) Pub. No.: US 2009/0245037 A1
(43) Pub. Date: Oct. 1, 2009

(54) Focus Servo Method, Optical Reproducing Method, and Optical Reproducing Apparatus

(76) Inventor: Daisuke UEDA, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/409,622

(22) Filed: Mar. 24, 2009

(30) Foreign Application Priority Data
Mar. 26, 2008 (JP) P2008-081456

(51) Int. Cl. G11B 7/00

(52) U.S. Cl. 369/44.13; 369/112.23; G9B/7

(57) ABSTRACT

A focus servo method includes: causing light to enter an objective lens at an eccentric position; irradiating light onto recording marks of an optical recording medium in an oblique direction with respect to a thickness direction of the optical recording medium; detecting light reflected by the recording marks as a reflection of the light irradiated onto the recording marks; and controlling a position of the objective lens based on the detected light.

### CROSS REFERENCES TO RELATED APPLICATIONS

The present invention contains subject matter related to Japanese Patent Application JP 2008-081456 filed in the Japanese Patent Office on Mar. 26, 2008, the entire contents of which being incorporated herein by reference.

### BACKGROUND OF THE INVENTION

1. Field of the Invention

The present invention relates to a focus servo method, an optical reproducing method, and an optical reproducing apparatus that are used at a time of reproducing information recorded on a recording medium.

2. Description of the Related Art

There has been proposed an optical disc for recording a standing wave on a recording medium as a next-generation optical disc of CDs (Compact Discs), DVDs (Digital Versatile Discs), and Blu-ray discs currently used.

For example, light is focused once on a recording medium whose refractive index is changed depending on an intensity of irradiation light, and then light is focused again on the same focal position in a reverse direction with a reflector provided on a back surface of the optical disc. As a result, a hologram of a small light-spot size is formed on the recording medium, to thereby record information.

When the information is reproduced, light reflected by a surface of the optical disc irradiated in the same way is read, to discriminate information (see, for example, “Microholographic multilayer optical disk data storage” by R. R. McLeod et al., Appl. Opt., Vol. 44, 2005, pp. 3197).

### SUMMARY OF THE INVENTION

However, in the related art, it has been necessary to provide, in reproducing information recorded on a volume-type optical recording medium, a reference surface on the optical recording medium to realize focus servo. By this method, in addition to time and effort required for producing the reference surface, it has been difficult to suppress optical aberrations extremely low when focusing light on both the reference surface and the recording surface at the same time, in a case of recording/reproducing at a signal recording position distant from the reference surface. Therefore, there has been a problem that a signal is deteriorated and follow-up of beams with respect to a recording/reproduction position becomes difficult. Moreover, when inserting the optical recording medium in a different recording/reproducing apparatus, settings of a relative distance with respect to the reference surface may slightly vary among different types of apparatuses, thus causing a problem that it becomes difficult to maintain reproducibility of a reproduction signal.

Further, in the optical recording/reproducing method of the related art as in the Blu-ray disc, for example, a clear reflection surface is present on each recording layer. Thus, it has been possible to directly obtain a focus signal from return light of the recording/reproducing light. However, in bit-by-bit volumetric recording, for example, it is often the case that a clear signal reflection surface is not set at the signal recording position, and only bits of a size equal to or smaller than a spot size are present. Because the bits are minute, there has been a problem that, even when a spot of a recording/reproducing beam scans the vicinity of the signal recording position in a thickness (depth) direction, the beam spot does not overlap the signal recording position, and the focus signal is thus not reproduced.

In view of the circumstances as described above, there is a need for a focus servo method, an optical reproducing method, and an optical reproducing apparatus that are capable of detecting a stable signal.

According to an embodiment of the present invention, there is provided a focus servo method including: causing light to enter an objective lens at an eccentric position; irradiating the light onto recording marks of an optical recording medium in an oblique direction with respect to a thickness direction of the optical recording medium; detecting light reflected by the recording marks as a reflection of the light irradiated onto the recording marks; and controlling a position of the objective lens based on the detected light.

In the embodiment of the present invention, although the light enters the objective lens at the eccentric position, because a size of a light spot in the thickness direction changes in accordance with the light-incident position, the light is caused to enter the objective lens at the eccentric position that is apart from a center thereof by a predetermined distance so that the light spot can positively be irradiated onto the recording marks and the recording marks positively reflect the light, and the reflected light is detected so that the position of the objective lens can be controlled based on the detected light, thus enabling detection of a stable signal.

The recording marks are formed with a predetermined in-plane interval in a direction within a recording surface of the optical recording medium and with a predetermined thickness interval in the thickness direction of the optical recording medium, and the objective lens refracts the light that has entered, to irradiate onto the recording marks a light spot whose size in the thickness direction varies depending on a distance from a center of the objective lens to the eccentric position.

Accordingly, light can positively be irradiated onto the recording marks by changing the size of the light spot in the thickness direction of the optical recording medium in accordance with the distance from the center of the objective lens to the eccentric position thereof.

The size of the light spot in the direction within the recording surface is larger than the predetermined in-plane interval, and the size thereof in the thickness direction is smaller than the predetermined thickness interval.

Accordingly, because it is possible to positively irradiate the light on only the recording marks of a predetermined layer without causing the light to be irradiated over the recording marks disposed across different layers of the optical recording medium in the thickness direction, a high-quality signal can be detected.

When a numerical aperture of the objective lens is represented by NA, a wavelength of the light is represented by λ, a diameter of light that enters the objective lens, that has been standardized by a pupil diameter of the objective lens is represented by φ, the predetermined distance is represented by x, the predetermined in-plane interval is represented by TPx, and the predetermined thickness interval is represented by TPz, the predetermined distance x satisfies 0<x<NA.

Accordingly, by setting the predetermined distance x to be larger than 0, the size of the light spot in the thickness direction can be made larger than a predetermined length, and the light spot can thus be positively irradiated onto the recording marks.

The size of the light spot in the thickness direction satisfies 2.5x+λ/(φ*NA)²<TPz.

Accordingly, by setting the predetermined distance x large, the size of the light spot in the thickness direction can be increased. Moreover, by setting the size of the light spot in the thickness direction to be smaller than TPz, it is possible to prevent the light spot from being irradiated onto the recording marks formed over a plurality of different layers on the optical recording medium in the thickness direction, and obtain a stable signal.

The size of the light spot in the direction within the recording surface satisfies 0.82*λ/(φ*NA)>TPx.

Accordingly, without depending on the predetermined distance x, the light can positively be irradiated onto the recording marks.

The light is light having no coherency with reproduction light used for reproducing the recording marks of the optical recording medium.

Accordingly, it is possible to prevent the light for the focus servo and the reproduction light for reproduction of the recording marks from interfering with each other, and detect a stable focus servo signal.

The light has a polarization component different from that of the reproduction light.

Accordingly, interference of light caused when the polarization components (polarization directions) of two light beams coincide can be prevented.

The light has a wavelength different from that of the reproduction light.

Accordingly, it is possible to prevent the light for the focus servo and the reproduction light for reproduction of the recording marks from interfering with each other, prevent the light spot from losing its shape, and detect a stable focus servo signal.

The light that enters the objective lens at the eccentric position is light generated by separating light that has entered a hologram element, by the hologram element.

Here, the hologram element includes a holographic diffraction grating, for example.

Accordingly, the light can be separated into reproduction light and focus servo light by the hologram element.

The light that enters the objective lens at the eccentric position is light generated by separating light that has entered a mask, by the mask.

Accordingly, the light can be separated into reproduction light and focus servo light by the mask.

According to an embodiment of the present invention, there is provided an optical reproducing method including: causing light to enter an objective lens at an eccentric position; irradiating the light onto recording marks of an optical recording medium in an oblique direction with respect to a thickness direction of the optical recording medium; detecting light reflected by the recording marks as a reflection of the light irradiated onto the recording marks; controlling a position of the objective lens based on the detected light; and reproducing recording information based on the light reflected by the recording marks using reproduction light irradiated onto the recording marks.

In the embodiment of the present invention, although the light enters the objective lens at the eccentric position, because a size of a light spot in the thickness direction changes in accordance with the light-incident position, the light is caused to enter the objective lens at a position that is apart from a center thereof by a predetermined distance so that the light spot can positively be irradiated onto the recording marks and the recording marks positively reflect the light, and the reflected light is detected so that the position of the objective lens can be controlled based on the detected light, thus enabling detect on of a stable signal. As a result, stable focus servo control can be carried out to stably reproduce recording information.

According to an embodiment of the present invention, there is provided an optical reproducing apparatus including: means for causing focus servo light to enter an objective lens at an eccentric position; the objective lens to refract the focus servo light that has entered the objective lens, to irradiate the focus servo light onto recording marks of an optical recording medium; a detection means for detecting light reflected by the recording marks as a reflection of the focus servo light irradiated onto the recording marks; means for controlling a position of the objective lens based on the detected light; and means for reproducing recording information based on the light reflected by the recording marks using reproduction light irradiated onto the recording marks.

In the embodiment of the present invention, although the focus servo light enters the objective lens at the eccentric position, because the size of the light spot, that is formed on the optical recording medium, in the thickness direction changes in accordance with the eccentric position, the focus servo light is irradiated onto the objective lens at the eccentric position so that the focus servo light can positively be irradiated onto the recording marks and the recording marks positively reflect the light, and the reflected light is detected so that the position of the objective lens is controlled based on the detected light, thus enabling detection of a stable focus servo signal. As a result, stable focus servo control can be carried out to stably reproduce recording information.

As described above, according to the embodiments of the present invention, a focus servo method with which a stable signal can be detected can be provided.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a diagram showing a structure of an optical system of an optical recording/reproducing apparatus according to an embodiment of the present invention;

FIG. 2 is an enlarged diagram of a region A of the optical system of the optical recording/reproducing apparatus shown in FIG. 1;

FIG. 3 is an enlarged diagram of a region B of the optical path diagram shown in FIG. 2;

FIG. 4 is a diagram showing a relationship between a predetermined distance x from a center O of an objective lens to a center of focus servo laser light and a light spot size m in an in-plane direction;

FIG. 5 is a diagram showing a relationship between the predetermined distance x from the center O of the objective lens to the center of the focus servo laser light and a light spot size z in a thickness direction;

FIG. 6 is a diagram obtained by standardizing the light spot size in the thickness direction by the light spot size in the thickness direction at the center of a pupil surface of the objective lens shown in FIG. 5;

FIG. 7 is a flowchart for illustrating an operation of focus servo and reproduction in the optical recording/reproducing apparatus;

FIG. 8 is a diagram showing optical paths at a time of reproduction of the optical recording/reproducing apparatus;

FIG. 9 is a diagram showing a structure of an optical system of an optical recording/reproducing apparatus according to a first modification;

FIG. 10 is a diagram showing a structure of an optical system of an optical recording/reproducing apparatus according to a second modification; and

FIG. 11 is a plan view of a mask of the optical recording/reproducing apparatus shown in FIG. 10.

### DESCRIPTION OF PREFERRED EMBODIMENTS

Hereinafter, an embodiment of the present invention will be described with reference to the drawings.

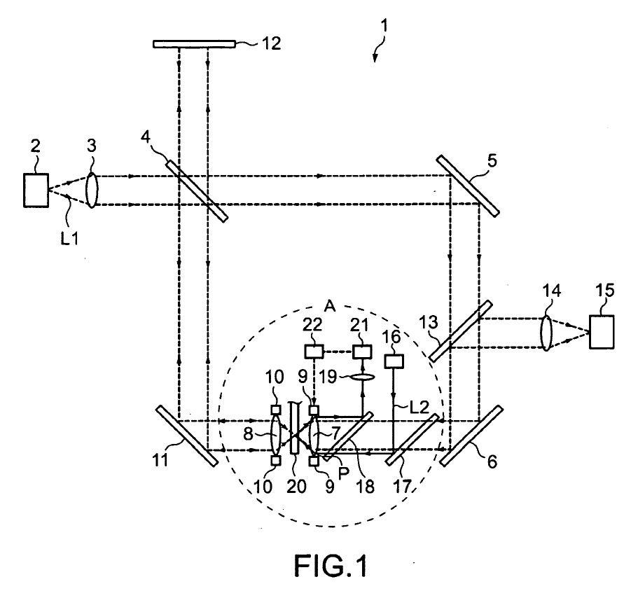

FIG. 1 is a diagram showing a structure of an optical system of an optical recording/reproducing apparatus 1 according to an embodiment of the present invention.

As shown in FIG. 1, the optical system of the optical recording/reproducing apparatus 1 includes a laser light source 2, a focusing lens 3, a beam splitter 4, mirrors 5 and 6, objective lenses 7 and 8, objective-lens actuators 9 and 10, a mirror 11, an optical path length adjustment mirror 12, a mirror 13, a focusing lens 14, a photodetector 15, a laser light source 16, mirrors 17 and 18, a focusing lens 19, a photodetector 21, and an objective-lens focus servo apparatus 22.

The laser light source 2 emits, for example, blue laser light L1 having a wavelength of about 405 nm toward the focusing lens 3.

The focusing lens 3 causes the blue laser light L1 emitted from the laser light source 2 to enter the beam splitter 4.

The beam splitter 4 divides the blue laser light L1 from the focusing lens 3 into light that advances in a direction of the mirror 5 and light that advances in a direction of the optical path length adjustment mirror 12.

The mirror 5 reflects the blue laser light L1 from the beam splitter 4 toward the mirror 6 via the mirror 13, and the mirror 6 reflects the blue laser light L1 from the mirror 5 toward the mirror 17. The blue laser light L1 reflected by the mirror 6 is transmitted through the mirrors 17 and 18 and enters the objective lens 7.

The objective lens 7 focuses the blue laser light L1 from the mirror 18 and generates a light spot on a recording medium 20.

Meanwhile, the optical path length adjustment mirror 12 reflects the blue laser light L1 that has entered from the beam splitter 4 toward the beam splitter 4. The optical path length adjustment mirror 12 is used to adjust an optical path length. The blue laser light L1 reflected by the optical path length adjustment mirror 12 is transmitted through the beam splitter 4, is reflected by the mirror 11, and enters the objective lens 8.

The objective lens 8 focuses the blue laser light L1 from the mirror 11 and generates a light spot on the recording medium 20. During recording of information (during formation of holograms as recording marks), the light spot and that generated by focusing the light by the objective lens 7 above interfere with each other in the recording medium 20, to thus form a hologram on the recording medium 20.

During reproduction, the blue laser light L1 emitted from the laser light source 2 is reflected by the mirrors 5 and 6, for example, and focused by the objective lens 7 to thus be irradiated onto the hologram on the recording medium 20. As a result, reproduction light reflected by the hologram enters the mirror 13 via the objective lens 7 and the mirrors 18, 17, and 6.

The mirror 13 reflects the reproduction light from the mirror 6 toward the focusing lens 14.

The focusing lens 11 focuses the reproduction light from the mirror 13 and irradiates the light onto the photodetector 15.

The photodetector 15 detects the reproduction light and outputs a signal to an information controller (not shown).

Accordingly, information is reproduced. For the photodetector 15, a split photodetector or a quadripartite position detection photodetector (position sensitive detector), for example, is used.

The photodetector 15 generates a focus error signal when predetermined reproduction light cannot be detected. This is because, when a distance between the objective lens 7 and the recording medium 20 is deviated, for example, the reproduction light from the recording medium 20 is deviated toward an outer circumference of the objective lens 7, and return light to the photodetector 15 is also focused at a position different from that at a time of correct focus.

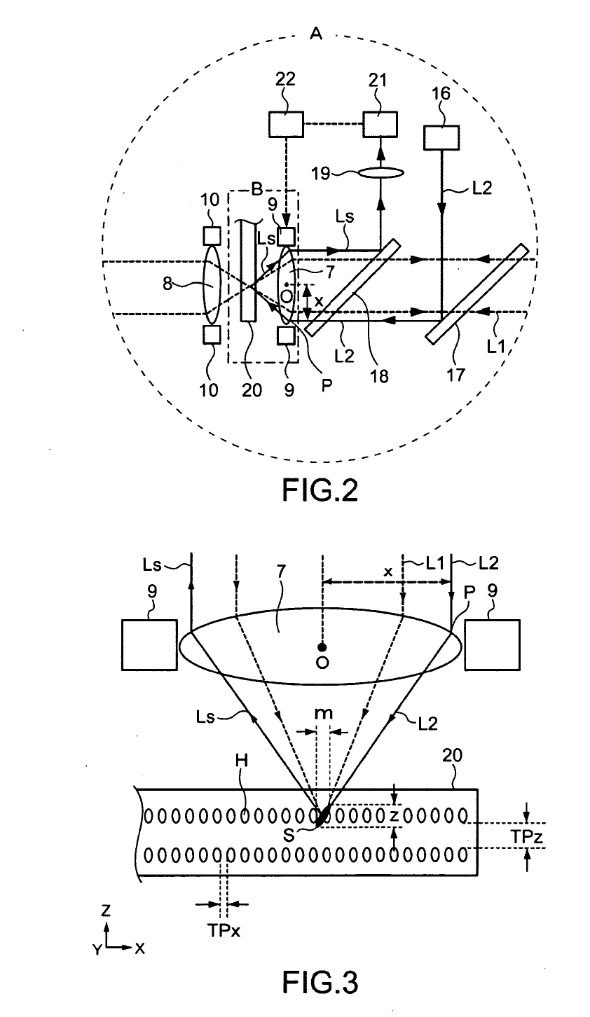

FIG. 2 is an enlarged diagram of a region A of the optical system of the optical recording/reproducing apparatus 1 shown in FIG. 1.

As shown in FIG. 2, the laser light source 16 emits, for example, focus servo laser light L2 having a wavelength different from that of about 405 nm toward the mirror 17.

The mirror 17 reflects the focus servo laser light L2 toward the mirror 18, and the mirror 18 transmits the focus servo laser light L2 from the mirror 17 therethrough. As a result, the focus servo laser light L2 enters the objective lens 7 at an eccentric position P that is apart from a center O by a predetermined distance x.

The objective lens 7 refracts the focus servo laser light L2 that has entered, and focuses the refracted focus servo laser light L2 on a focal point of the blue laser light L1. Accordingly, the focus servo laser light L2 is irradiated onto a predetermined hologram of the recording medium 20.

Reproduction light Ls as a reflection of the focus servo laser light L2 reflected by the hologram enters the objective lens 7 at a tip end thereof, is refracted by the objective lens 7 toward the mirror 18, and is reflected by the mirror 18 toward the focusing lens 19.

The focusing lens 19 focuses the reproduction light Ls from the mirror 18 on the photodetector 21.

The photodetector 21 uses the reproduction light Ls from the focusing lens 19 as focus servo light. In other words, based on the focus servo light, the photodetector 21 outputs a signal to the objective-lens focus servo apparatus 22 by, for example, an astigmatic method.

Based on the signal from the photodetector 21, the objective-lens focus servo apparatus 22 outputs a control signal for controlling the objective-lens actuator 9.

Based on the control signal from the objective-lens focus servo apparatus 22, the objective-lens actuator 9 moves the objective lens 7 for focus servo control. The objective-lens actuator 10 also carries out focus servo control of the objective lens 8 in a similar manner.

FIG. 3 is an enlarged diagram of a region B of the optical path diagram shown in FIG. 2.

On the recording medium 20, a plurality of holograms H are formed with predetermined in-plane intervals TPx and TPy in a direction within a recording surface (X and Y directions shown in FIG. 3), and a plurality of holograms H are formed with a predetermined thickness interval TPz in a thickness direction (Z direction shown in FIG. 3). The predetermined in-plane interval TPx or TPy is a track pitch of the holograms H, for example. FIG. 3 shows an example where two layers of recording surfaces are formed in the recording medium 20 in the Z direction. However, the present invention is not limited thereto, and recording surfaces of three layers or more may be formed in the Z direction.

When the numerical aperture of the objective lens 7 is represented by NA, the wavelength of the focus servo laser light L2 is represented by λ, a diameter of the focus servo laser light L2 that enters the objective lens 7, that has been standardized by a pupil diameter of the objective lens 7, is represented by φ, the predetermined distance is represented by x, the predetermined in-plane interval is represented by TPx, the predetermined thickness interval is represented by TPz, a light spot size as a size of a light spot S generated in the recording medium 20 in the in-plane direction (X direction) is represented by m, and a light spot size as a size of the light spot S generated in the recording medium 20 in the thickness direction (Z direction) is represented by z, respective values are set so as to satisfy the following expressions.

Light spot size m=0.82*λ/(φ*NA)>TPx (Expression 1)

Light spot size z=2.5x+λ/(φ*NA)²<TPz (Expression 2)

0<x<NA (Expression 3)

Expression 1 shows that the respective values are set so that the light spot size m is larger than the predetermined in-plane interval TPx, that is, the light spot S is irradiated onto at least one of the plurality of holograms H formed in the X direction.

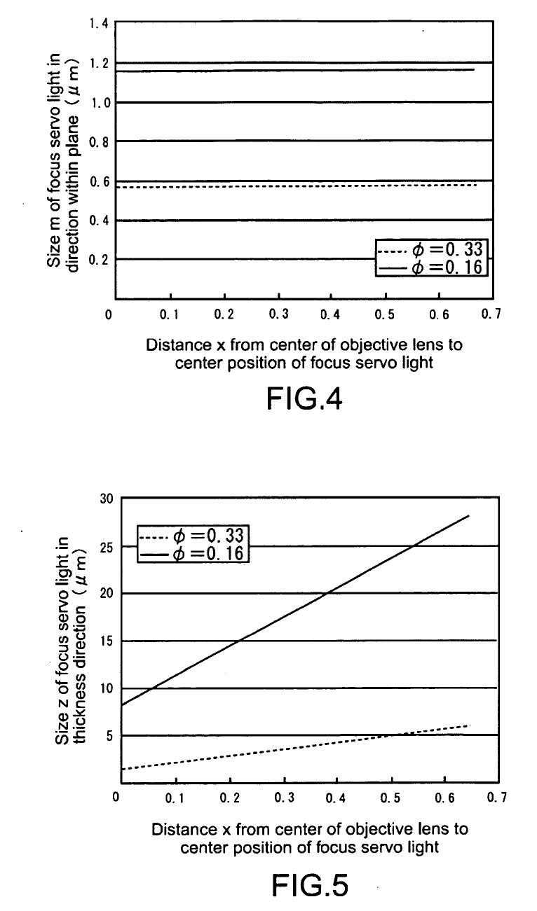

As expressed in Expression 1, the light spot size m does not depend on the predetermined distance x. This is also apparent from the experiment shown in FIG. 4.

FIG. 4 is a diagram showing a relationship between the predetermined distance x from the center O of the objective lens 7 to a center of the focus servo laser light L2 and the light spot size m in the in-plane direction.

As shown in FIG. 4, when the diameter φ of the focus servo laser light L2 is set to 0.16 or 0.33 (pupil diameter of objective lens 7 being standardized to 1) and the predetermined distance x is changed between 0 to 0.7 (pupil diameter of objective lens 7 being standardized to 1), the light spot size m of the focus servo laser light L2 in the in-plane direction (X direction) hardly changes.

Expression 2 shows that the respective values are set so that the light spot size z as the size of the light spot S in the Z direction is smaller than the predetermined thickness interval TPz, that is, the light spot S is not irradiated onto the holograms H over a plurality of layers.

As expressed in Expression 2, the light spot size z changes in accordance with the predetermined distance x. This is apparent from the experiment shown in FIG. 5.

FIG. 5 is a diagram showing a relationship between the predetermined distance x from the center O of the objective lens 7 to the center of the focus servo laser light L2 and the light spot size z in the thickness direction.

As shown in FIG. 5, when the diameter φ of the focus servo laser light L2 is set to 0.16 or 0.33 (pupil diameter of objective lens 7 being standardized to 1) and the predetermined distance x is changed between 0 to 0.7 (pupil diameter of objective lens 7 being standardized to 1), the light spot size z of the focus servo laser light L2 in the thickness direction (Z direction) changes linearly.

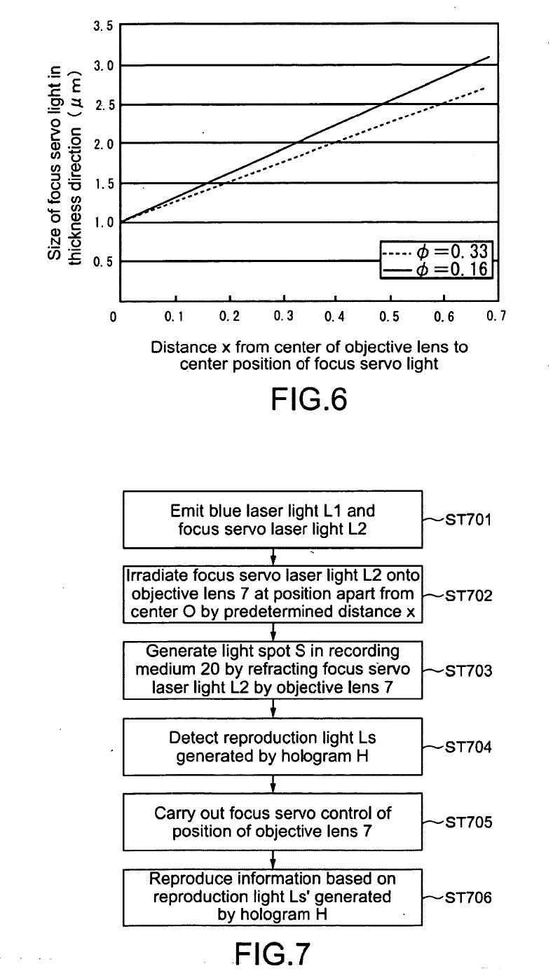

FIG. 6 is a diagram obtained by standardizing the light spot size z by the light spot size z at the center O of the pupil surface of the objective lens 7 shown in FIG. 5.

It can be seen from FIG. 6 that when the diameter φ of the focus servo laser light L2 is set to 0.33, a tilt α is equal to 2.5.

In other words, assuming that the light spot size z is z0 when the predetermined distance x is 0, the light spot size z of the focus servo laser light L2 in the thickness direction is expressed as follows.

z=2.5x+z0 (Expression 4)

Generally, the light spot size z at a focal point of the objective lens 7 is expressed as follows.

z0=λ/(φ*NA)² (Expression 5)

The light spot size z shown on the left-hand side of Expression 2 is determined based on Expressions 4 and 5.

Expression 3 shows that the respective values are set so that the predetermined distance x is smaller than NA but larger than 0, that is, the light spot size z in the Z direction becomes larger than z0 and smaller than TPz.

Positions of, for example, the laser light source 16 and the mirror 17 are set such that the predetermined distance x satisfies 0<x<NA.

Next, descriptions will be given on a method of reproducing information recorded on the recording medium 20 using the optical recording/reproducing apparatus 1.

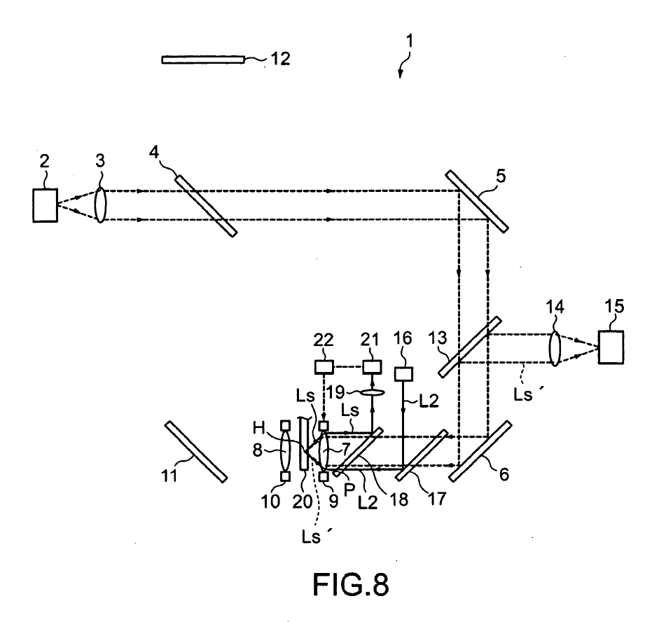

FIG. 7 is a flowchart for illustrating an operation of focus servo and reproduction in the optical recording/reproducing apparatus 1, and FIG. 8 is a diagram showing optical paths at a time of reproduction of the optical recording/reproducing apparatus 1.

The laser light source 2 of the optical recording/reproducing apparatus 1 shown in FIG. 8 emits the blue laser light L1 for data reproduction toward the focusing lens 3, and the laser light source 16 emits the focus servo laser light L2 toward the mirror 17 (ST 701).

As shown in FIG. 8, the focus servo laser light L2 emitted toward the mirror 17 from the laser light source 16 is reflected by the mirror 17, is transmitted through the mirror 18, and enters the objective lens 7. At this time, the focus servo laser light L2 enters the objective lens 7 at a position apart from the center O by the predetermined distance x (see FIGS. 2 and 3) (ST 702).

The focus servo laser light L2 that has entered the objective lens 7 is refracted by the objective lens 7 so that the light spot S is irradiated onto the hologram H of the recording medium 20 (ST 703).

The reproduction light Ls generated by the light spot S through the hologram H enters the objective lens 7 and is refracted thereby as shown in FIG. 8, and enters the mirror 18 thereafter and is reflected thereby toward the focusing lens 19. The reproduction light Ls that has entered the focusing lens 19 is focused by the focusing lens 19 and enters the photodetector 21. Accordingly, the photodetector 21 detects the reproduction light Ls for focus servo (ST 704).

The photodetector 21 uses the reproduction light Ls from the focusing lens 19 as focus servo light and outputs a signal to the objective-lens focus servo apparatus 22 by, for example, the astigmatic method based on the focus servo light.

Based on the signal from the photodetector 21, the objective-lens focus servo apparatus 22 outputs a control signal for controlling the objective-lens actuator 9.

Based on the control signal from the objective-lens focus servo apparatus 22, the objective-lens actuator 9 moves the objective lens 7 for focus servo control (ST 705). The objective-lens actuator 10 similarly carries out focus servo control of the objective lens 8.

The focus servo control of the objective lenses 7 and 8 is carried out as described above.

Meanwhile, as shown in FIG. 8, a part of the blue laser light L1 emitted from the laser light source 2 and that has entered the focusing lens 3 is transmitted through the beam splitter 4, reflected by the mirror 5, transmitted through the mirror 13, reflected by the mirror 6, and transmitted through the mirrors 17 and 18, to thus enter the objective lens 7.

The objective lens 7 focuses the blue laser light L1 that has entered the pupil surface thereof, and generates a light spot on the hologram H of the recording medium 20.

At this time, because the position of the objective lens 7 is already under focus servo control, the light spot of the blue laser light L1 focused by the objective lens 7 is positively irradiated onto at least one hologram H in a predetermined layer without being irradiated onto the holograms H over the plurality of layers in the recording medium 20. Accordingly, reproduction light Ls′ is reflected by the hologram H.

The reproduction light Ls′ reflected by the hologram H enters the objective lens 7 and then enters the mirror 13 via the mirrors 18, 17, and 6. The reproduction light Ls′ that has entered the mirror 13 is reflected by the mirror 13 toward the focusing lens 14, focused by the focusing lens 14, and detected by the photodetector 15, whereby stable information is reproduced by an output signal from the photodetector 15 (ST 706).

As described above, according to this embodiment, although the focus servo laser light L2 enters the objective lens 7 at the eccentric position P apart from the center O by the predetermined distance x, because the light spot size z as the size of the light spot S in the thickness direction (Z direction) varies depending on the predetermined distance x, the focus servo laser light L2 is caused to enter the objective lens 7 at a position apart from the center O by the predetermined distance x so that the light spot S of the focus servo laser light L2 is positively irradiated onto the hologram H of the recording medium 20 and the hologram H positively reflects the light to obtain the reproduction light Ls, and the reproduction light Ls is detected by the photodetector 21 so that the position of the objective lens 7 is controlled by the objective-lens actuator 9 based on the detected reproduction light Ls, to thus enable detection of a stable focus servo signal by the photodetector 21.

As a result, under stable focus servo control, it is possible to positively irradiate the blue laser light L1 onto the hologram H of a predetermined layer, detect the stable reproduction light Ls′ by the photodetector 15, and thus stably reproduce recording information.

Focus servo control can automatically be carried out on the hologram H on an arbitrary recording surface. Consequently, information that has been recorded on a recording medium using an optical recording/reproducing apparatus different from the optical recording/reproducing apparatus 1 can be stably reproduced using the optical recording/reproducing apparatus 1.

A position of the mirror 17 is set such that the predetermined distance x satisfies 0<x<NA, for example. Accordingly, by setting the predetermined distance x to be larger than 0, the light spot size z of the light spot S in the thickness direction can be made larger than a predetermined length, and the light spot S can thus be positively irradiated onto the hologram H of the recording medium 20.

The light spot size m of the light spot S in the direction within the recording surface (X direction in FIG. 3) is larger than the predetermined in-plane interval TPx, and the light spot size z thereof in the thickness direction (Z direction in FIG. 3) is smaller than the predetermined thickness interval TPz. Accordingly, because the focus servo laser light L2 can positively be irradiated onto only the hologram H of a predetermined layer without being irradiated onto the holograms H over the plurality of different layers in the thickness direction of the recording medium 20 (Z direction in FIG. 3), a high-quality focus servo signal can be detected.

Because the blue laser light L1 and the focus servo laser light L2 have different wavelengths, the light beams can be prevented from interfering with each other. As a result, accurate focus servo control and information reproduction can be carried out.

Next, an optical recording/reproducing apparatus according to a first modification will be described. It should be noted that in this and subsequent modifications, structural components and the like that are similar to those of the above embodiment are denoted by the same reference symbols, and descriptions thereof will be omitted. Moreover, points different therefrom will mainly be described.

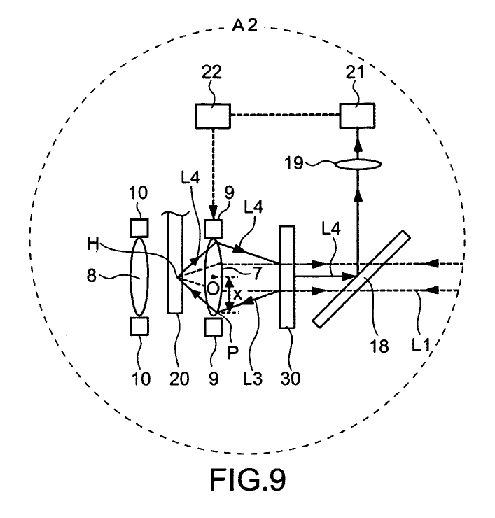

FIG. 9 is a diagram showing a structure of an optical system of the optical recording/reproducing apparatus according to the first modification.

The optical system of the optical recording/reproducing apparatus of this modification is different from the optical recording/reproducing apparatus 1 of the above embodiment in the point of including a region A2 shown in FIG. 9 instead of the region A shown in FIG. 2.

Specifically, the optical system of the optical recording/reproducing apparatus of this modification is different from the optical recording/reproducing apparatus 1 of the above embodiment in the point of including a hologram element 30 between the objective lens 7 and the mirror 18 as shown in FIG. 9, and excluding the laser light source 16 and the mirror 17 shown in FIG. 2.

The hologram element 30 is, for example, a holographic diffraction grating formed with a plurality of grooves. The hologram element 30 includes a function of separating the light that has entered the hologram element 30 into light beams in predetermined directions.

Subsequently, an information reproduction operation that uses the optical recording/reproducing apparatus of this modification will be described.

As shown in FIG. 9, upon being transmitted through the mirror 18 and entering the hologram element 30, the blue laser light L1 is separated (diffracted) into the blue laser light L1 for information reproduction and focus servo laser light L3 by the hologram element 30.

The focus servo laser light L3 into which the light has been separated by the hologram element 30 enters the objective lens 7 at the eccentric position P apart from the center O by the predetermined distance x.

The focus servo laser light L3 that has entered the objective lens 7 is refracted by the objective lens 7 so as to overlap a focal point of the blue laser light L1, and irradiated onto the hologram H of the recording medium 20.

Reproduction light L4 reflected by the hologram H enters the objective lens 7 and is refracted thereby, to thus reenter the hologram element 30.

The reproduction light L4 transmitted through the hologram element 30 is reflected by the mirror 18 toward the focusing lens 19. The reproduction light L4 that has entered the focusing lens 19 is focused and thereafter enters the photodetector 21. Hereinafter, because an operation of focus servo control of the objective lens 7 is the same as in the above embodiment, descriptions thereof will be omitted.

As described above, in this modification, because it is possible to separate the blue laser light L1 from a single laser light source 2 into the blue laser light L1 for reproduction and the focus servo laser light L3 by the hologram element 30, a stable focus servo signal can be obtained and stable information reproduction can thus be carried out, while suppressing production costs.

In this case, it is desirable that the focus servo laser light L3, into which the light has been separated by the hologram element 30, be caused to enter a wavelength dispersion mirror (not shown), and focus servo laser light having a wavelength different from that of the blue laser light L1 for reproduction be used as the focus servo light. The wavelength dispersion mirror only needs to be disposed on an optical path of the focus servo laser light L3 between the hologram element 30 and the objective lens 7, for example.

In this case, because the focus servo laser light L3 that has been transmitted through the wavelength dispersion mirror and the blue laser light L1 for reproduction have different wavelengths, the light beams are prevented from interfering with each other, thus enabling stable focus servo control.

In this modification, the example where the blue laser light L1 and the focus servo laser light L3 overlap each other on the same hologram H of the same layer of the recording medium 20 has been shown. However, the focus servo control can be executed also when the light beams do not overlap each other.

Next, an optical recording/reproducing apparatus according to a second modification will be described.

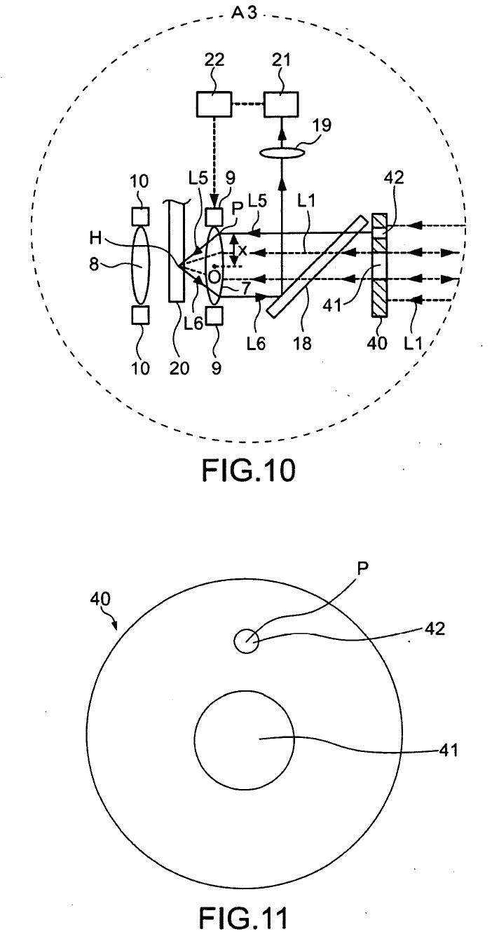

FIG. 10 is a diagram showing a structure of an optical system of the optical recording/reproducing apparatus according to the second modification. FIG. 11 is a plan view of a mask of the optical recording/reproducing apparatus shown in FIG. 10.

The optical system of the optical recording/reproducing apparatus of this modification is different from the optical recording/reproducing apparatus 1 in the point of including a region A3 shown in FIG. 10 instead of the region A shown in FIG. 2.

Specifically, the optical system of the optical recording/reproducing apparatus of this modification is different from the optical recording/reproducing apparatus 1 in the point of including a mask 40 shown in FIG. 10 and excluding the laser light source 16 and the mirror 17 shown in FIG. 2.

The mask 40 is disposed between the mirror 18 and the mirror 6 (not shown in FIG. 10) (see FIG. 1) for separating the blue laser light L1 that has entered the mask 40 into laser light for reproduction and laser light for focus servo. As shown in FIG. 11, the mask 40 has a hole 41 through which the blue laser light L1 for reproduction is transmitted and a hole 42 through which focus servo laser light L5 is transmitted formed therein. A diameter φ of the hole 42 is set to, when a pupil diameter of the objective lens 7 is assumed to be 1, 0.18 or 0.33, for example.

An information reproduction operation that uses the optical recording/reproducing apparatus of this modification will be described.

As shown in FIG. 10, upon entering the mask 40, the blue laser light L1 is separated into the blue laser light L1 for reproduction and the focus servo laser light L5 by the mask 40.

The focus servo laser light L5 into which the blue laser light L1 has been separated by the mask 40 enters the objective lens 7 at the eccentric position P apart from the center O by the predetermined distance x.

The focus servo laser light L5 that has entered the objective lens 7 is refracted so as to overlap the point at which the blue laser light L1 is focused by the objective lens 7, and is then irradiated onto the hologram H of the recording medium 20.

Reproduction light L6 as a reflection by the hologram H enters the objective lens 7 at an end thereof, is refracted by the objective lens 7, and enters the mirror 18.

The reproduction light L6 that has entered the mirror 18 is reflected by the mirror 18 toward the focusing lens 19. Hereinafter, because an operation of focus servo control is the same as in the above embodiment, descriptions thereof will be omitted.

As described above, according to this modification, by using an inexpensive mask 40 having a simple structure while excluding the laser light source 16, the blue laser light L1 can be separated into the blue laser light L1 for reproduction and the focus servo laser light L5 so that stable focus servo control can be carried out at a low cost using the focus servo laser light L5.

It should be noted that the present invention is not limited to the above embodiment, and various modifications can be made within the scope of the technical idea of the present invention.

In the first and second modifications, the example where the blue laser light L1 from a single laser light source 2 is separated into the blue laser light L1 for reproduction and the focus servo laser light L3 (L5) has been shown. However, it is desirable to use a low-coherency LED (Light Emitting Diode) instead of the laser light source 2, lower a coherency of the focus servo laser light L3 (L5) from the laser light source 2 using a depolarizer or a diffusion plate, or change an optical path length of the focus servo laser light L3 (L5) from the laser light source 2 so that coherence lengths do not overlap each other.

In the case of the first modification, for example, it is desirable to provide a phase modification plate such as a λ/2 wavelength plate on the optical path of the focus servo laser light L3 into which the blue laser light L1 has been separated by the hologram element 30. Accordingly, the polarization components of the blue laser light L1 for reproduction and the focus servo laser light L3 are differentiated (e.g., so as to be orthogonal to each other) so that it is possible to prevent interference and carry out stable focus servo control.

What is claimed is:

1. A focus servo method, comprising:
causing light to enter an objective lens at an eccentric position;
irradiating the light onto recording marks of an optical recording medium in an oblique direction with respect to a thickness direction of the optical recording medium;
detecting light reflected by the recording marks as a reflection of the light irradiated onto the recording marks; and
controlling a position of the objective lens based on the detected light.

2. The focus servo method according to claim 1,
wherein the recording marks are formed with a predetermined in-plane interval in a direction within a recording surface of the optical recording medium and with a predetermined thickness interval in the thickness direction of the optical recording medium, and
wherein the objective lens refracts the light that has entered, to irradiate onto the recording marks a light spot whose size in the thickness direction varies depending on a distance from a center of the objective lens to the eccentric position.

3. The focus servo method according to claim 2,
wherein the size of the light spot in the direction within the recording surface is larger than the predetermined in-plane interval, and the size thereof in the thickness direction is smaller than the predetermined thickness interval.

4. The focus servo method according to claim 2,
wherein, when a numerical aperture of the objective lens is represented by NA, a wavelength of the light is represented by λ, a diameter of light that enters the objective lens, that has been standardized by a pupil diameter of the objective lens is represented by φ, the distance is represented by x, the predetermined in-plane interval is represented by TPx, and the predetermined thickness interval is represented by TPz, the distance x satisfies 0<x<NA.

5. The focus servo method according to claim 4,
wherein the size of the light spot in the thickness direction satisfies 2.5x+λ/(φ*NA)²<TPz.

6. The focus servo method according to claim 4,
wherein the size of the light spot in the direction within the recording surface satisfies 0.82*λ/(φ*NA)>TPx.

7. The focus servo method according to claim 1,
wherein the light is light having no coherency with reproduction light used for reproducing the recording marks of the optical recording medium.

8. The focus servo method according to claim 7,
wherein the light has a polarization component different from that of the reproduction light.

9. The focus servo method according to claim 7,
wherein the light has a wavelength different from that of the reproduction light.

10. The focus servo method according to claim 1,
wherein the light that enters the objective lens at the eccentric position is light generated by separating light that has entered a hologram element, by the hologram element.

11. The focus servo method according to claim 1,
wherein the light that enters the objective lens at the eccentric position is light generated by separating light that has entered a mask, by the mask.

12. An optical reproducing method, comprising:
causing light to enter an objective lens at an eccentric position;
irradiating the light onto recording marks of an optical recording medium in an oblique direction with respect to a thickness direction of the optical recording medium;
detecting light reflected by the recording marks as a reflection of the light irradiated onto the recording marks;
controlling a position of the objective lens based on the detected light; and
reproducing recording information based on the light reflected by the recording marks using reproduction light irradiated onto the recording marks.

13. The optical reproducing method according to claim 12,
wherein a size of a light spot in a direction within a recording surface of the optical recording medium is larger than a predetermined in-plane interval, and the size thereof in the thickness direction is smaller than a predetermined thickness interval.

14. The optical reproducing method according to claim 12,
wherein, when a numerical aperture of the objective lens is represented by NA, a wavelength of the light is represented by λ, a diameter of light that enters the objective lens, that has been standardized by a pupil diameter of the objective lens is represented by φ, a distance from a center of the objective lens to the eccentric position is represented by x, a predetermined in-plane interval is represented by TPx, and a predetermined thickness interval is represented by TPz, the distance x satisfies 0<x<NA.

15. An optical reproducing apparatus, comprising:
means for causing focus servo light to enter an objective lens at an eccentric position;
the objective lens to refract the focus servo light that has entered the objective lens, to irradiate the focus servo light onto recording marks of an optical recording medium;
a detection means for detecting light reflected by the recording marks as a reflection of the focus servo light irradiated onto the recording marks;
means for controlling a position of the objective lens based on the detected light; and
means for reproducing recording information based on the light reflected by the recording marks using reproduction light irradiated onto the recording marks.

16. The optical reproducing apparatus according to claim 15,
wherein a size of a light spot in a direction within a recording surface of the optical recording medium is larger than a predetermined in-plane interval, and the size thereof in a thickness direction is smaller than a predetermined thickness interval.

17. The optical reproducing apparatus according to claim 15,
wherein, when a numerical aperture of the objective lens is represented by NA, a wavelength of the light is represented by λ, a diameter of light that enters the objective lens, that has been standardized by a pupil diameter of the objective lens is represented by φ, a distance from a center of the objective lens to the eccentric position is represented by x, a predetermined in-plane interval is represented by TPx, and a predetermined thickness interval is represented by TPz, the distance x satisfies 0<x<NA.
